(19) United States
(12) Patent Application Publication
(10) Pub. No.: US 2025/0030106 A1
(43) Pub. Date: Jan. 23, 2025

(54) CLAMP ASSEMBLY WITH A CELL HOLDER AND A PLURALITY OF ELECTROCHEMICAL ENERGY STORAGE ELEMENTS

(71) Applicant: VARTA Microbattery GmbH, Ellwangen Jagst (DE)

(72) Inventor: Harald Schnirch, Westhausen-Reichenbach (DE)

(21) Appl. No.: 18/766,851

(22) Filed: Jul. 9, 2024

(30) Foreign Application Priority Data
Jul. 18, 2023 (EP) 23186224.4

(51) Int. Cl. H01M 50/264; H01M 50/213; H01M 50/291; H01M 50/293

(52) U.S. Cl. CPC H01M 50/264; H01M 50/213; H01M 50/291; H01M 50/293

(57) ABSTRACT

A clamp assembly is provided for a plurality of electrical energy storage elements in the form of cylindrical round cells, each having a shell surface and two end faces. The clamp assembly includes a one-piece cell holder comprising a plurality of recesses. Each recess has a triangular or polygonal shape and a corresponding number of walls. The cell holder is made of plastic. Each respective electrical energy storage element is clamped in a respective recess in the cell holder with the cell holder engaging in a region of the shell surface of the respective electrical energy storage element. End faces of each respective energy storage element are located outside the cell holder.

### CROSS REFERENCE TO RELATED APPLICATIONS

This application claims benefit to European Patent Application No. EP 23186224.4, filed on Jul. 18, 2023, which is hereby incorporated by reference herein.

### FIELD

The present disclosure relates to a clamp assembly comprising a cell holder and a plurality of electrical energy storage elements in the form of cylindrical round cells, and to a battery comprising such a clamp assembly.

### BACKGROUND

Batteries are rechargeable electrical energy storage devices that are used in automotive applications, for example, but also in many other areas. In a battery, several electrochemical energy storage cells are connected in order to provide the electrical currents and voltages required for various applications.

In the present case, an energy storage element is understood to mean both a single electrochemical cell capable of storing electrical energy and a battery with several electrically connected electrochemical cells capable of storing electrical energy.

Each electrochemical energy storage element comprises one or more electrochemical cells. An electrochemical cell within the meaning of the present application comprises at least one positive and at least one negative electrode, which are separated from each other for example by a separator. In electrochemical cells, an electrochemical, reaction takes place, which is composed of two electrically coupled but spatially separated partial reactions. One partial reaction takes place at a comparatively low redox potential at the negative electrode and one at a comparatively high redox potential at the positive electrode. During discharge, electrons are released at the negative electrode due to an oxidation process, resulting in a flow of electrons via an external consumer to the positive electrode, from which a corresponding quantity of electrons is absorbed. A reduction process therefore takes place at the positive electrode. At the same time, an ion current corresponding to the electrode reaction occurs within the electrochemical cell for the purpose of charge equalization. This ion current, which is made possible by an ion-conducting electrolyte, passes through the separator.

In secondary (rechargeable) electrochemical cells, this discharge reaction is reversible, i.e. it is possible to reverse the conversion of chemical energy into electrical energy during discharge.

For applications in the everyday environment or in the household, for example for telephones, household appliances, tools, electric bicycles, electric scooters or similar, so-called accumulators are generally used, i.e. rechargeable electrochemical energy storage elements. In accumulators, either single electrochemical energy storage cells or battery packs/battery modules comprising several electrochemical energy storage cells are used.

Larger batteries or battery systems are usually made up of battery modules, which generally comprise a large number of connected electrochemical energy storage cells. The number of energy storage cells contained in a battery module depends on the required currents and voltages. Applications in the field of electromobility or for large stationary energy storage systems generally require very high currents and high voltages and a correspondingly large number of energy storage cells.

One electrochemical cell often used in batteries is the lithium-ion cell. It comprises electrodes that can reversibly absorb and release lithium ions, as well as an electrolyte containing lithium ions.

Various designs are known for electrochemical cells and especially for lithium-ion cells. In addition to prismatic shapes, button cells and cylindrical round cells are widely used. Both button cells and round cells have an essentially circular base. Cylindrical round cells differ from button cells in that button cells have a height that is smaller than their diameter. Cylindrical round cells, on the other hand, have a height that is greater than their diameter.

Batteries or battery modules are often equipped with a prismatic housing. The energy storage elements are arranged inside the housing, whereby a holding matrix, also known as a cell holder, is often used to position and fix the energy storage elements inside the housing. In the case of cylindrical round cells, a two-part cell holder made of plastic is generally used, which fixes and frames the round cells, which are aligned parallel along their longitudinal axes, in the area of their end faces.

A two-part cell holder is shown in EP 3926704 A1, for example. This describes a battery module comprising two or more battery blocks. Each battery block comprises a plurality of cylindrical round cells, which are arranged in corresponding receptacles of a cell holder. The round cells are arranged in a regular pattern in several rows. The cell holder is subdivided into a lower cell holder element and an upper cell holder element, whereby the end faces of the cylindrical round cells are each enclosed and fixed by the upper cell holder element and the lower cell holder element respectively.

DE 102021125265 A1 discloses a holding structure for the energy storage cells of an energy storage device. A structure made of plastic forms a holding space for the individual battery cells, with the holding space forming a honeycomb-like structure. The holding space for the individual energy storage cells is cup-shaped.

DE 202018005411 U1 describes a battery module with round cells, wherein the round cells are held by a holding matrix made of plastic with precisely fitting receptacles in the form of cylindrical cavities and an upper and lower holding frame. The battery module described does not have a housing as such. Instead, the housing functions are performed by the self-supporting plastic holding matrix.

CN 217903281 U describes a holding structure for energy storage cells with a honeycomb-like structure. On the underside of each opening of the honeycomb structure, which is intended to hold an energy storage cell, there are six protrusions that prevent the energy storage cells from falling out.

### SUMMARY

In an embodiment, the present disclosure provides a clamp assembly for a plurality of electrical energy storage elements in the form of cylindrical round cells, each having a shell surface and two end faces. The clamp assembly includes a one-piece cell holder comprising a plurality of recesses. Each recess has a triangular or polygonal shape and a corresponding number of walls. The cell holder is made of plastic. Each respective electrical energy storage element is clamped in a respective recess in the cell holder with the cell holder engaging in a region of the shell surface of the respective electrical energy storage element. End faces of each respective energy storage element are located outside the cell holder.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 provides a view of a cell holder;

FIG. 2 provides a detailed view of the cell holder shown in FIG. 1;

FIG. 3 provides a view of a section of a clamp assembly with the cell holder shown in FIG. 1 and with cylindrical round cells inserted therein;

FIG. 4 provides an oblique view of the upper side of a clamp assembly; and

FIG. 5 provides an oblique view of the underside of a clamp assembly.

### DETAILED DESCRIPTION

The present disclosure provides for an improved way of holding and fixing energy storage elements within a battery. In particular, this is intended to simplify the production of batteries and use fewer components.

The present disclosure provides a clamp assembly with a cell holder and a plurality of electrical energy storage elements. The present disclosure further provides a battery including such a clamp assembly.

A clamp assembly according to an aspect of the present disclosure comprises a cell holder and a plurality of electrical energy storage cells. The electrical energy storage elements are designed as cylindrical round cells and in particular have a cylindrical housing with a shell surface and two end faces. The clamp assembly is characterized by the following features:
a. The cell holder is a one-piece cell holder;
b. The cell holder is made of plastic;
c. The cell holder has a plurality of recesses with a triangular or polygonal shape with a corresponding number of walls;
d. The individual energy storage elements are each clamped in a recess in the cell holder, with the cell holder engaging in the area of the shell surface of the energy storage elements;
e. The end faces of the individual energy storage elements are located outside the cell holder.

The cell holder, which can also be referred to as a holding matrix, is for example an injection-molded part made of plastic. A particular advantage of plastic as a material for the cell holder is its relatively light weight and its electrically insulating properties.

The cell holder is designed such that it has several recesses. These recesses can also be referred to as receptacles into which the individual energy storage elements of the clamp assembly are inserted. Further elements for positioning and fixing the energy storage cells are not required. In particular, no additional frames or the like need to be used.

An important feature of the clamp assembly is that the cell holder engages in the area of the shell surface, in particular in a middle area of the energy storage elements. This has the particular advantage that the ends of the energy storage elements, i.e. in particular the end faces of the cylindrical round cells (pole sides), are exposed and are not covered by the cell holder. This allows free access to the cell ends, which can be used for electrical contacting of the energy storage elements, for example for welding with cell connectors or other arresters.

Another particular advantage is that the exposed cell ends of the energy storage elements allow heat to be transferred directly to a battery housing, for example. The heat generated when discharging or charging the energy storage elements can therefore be dissipated directly via a flat heat dissipation system, so that the temperature management of a battery equipped with such a clamp assembly can be realized in an advantageous way compared to conventional batteries. In particular, overheating of the battery is prevented by the good heat dissipation.

A further particular advantage of the clamp assembly is that the energy storage elements are clamped in the cell holder and therefore no additional assembly step is required for fixing the energy storage elements in the cell holder during assembly. Assembling the energy storage elements in the form of a clamp assembly with the cell holder also makes assembly casier, as the energy storage elements are already fixed in the assembly when they are inserted into a housing, for example. The clamping also prevents the energy storage elements from having radial play in relation to the holder during operation of the battery and from moving. The clamping therefore prevents undesirable shear forces, particularly with regard to the welded connections between the energy storage elements and their respective electrical arrester elements, which could occur, for example, as a result of vibrations or other shocks to which the battery is exposed during operation.

The one-piece design of the cell holder facilitates the assembly of a battery with such a clamp assembly, since, for example, screw connections or other connections of several parts of a cell holder, as is conventionally required, are not necessary with the clamp assembly. The number of components is reduced by the one-piece design of the cell holder, which is also advantageous for cost reasons and also simplifies assembly.

In a preferred embodiment, the cell holder does not encompass the entire surface of the individual energy storage elements, but only partially. This has advantages with regard to possible heat generation within a battery equipped with such clamp assemblies, as the heat generated can be dissipated particularly well from the energy storage elements.

The arrangement of the cylindrical round cells within the cell holder can, for example, be designed such that the cell holder engages in a middle segment of the cylindrical round cells, referring to the longitudinal extent of the shell surface. The end segments and thus the end faces are located outside the cell holder. It is also possible for the cell holder to grip more than only the middle part of the shell surface. Preferably, at least one tenth, with respect to the longitudinal extent of the shell surface, is located outside the cell holder and is therefore available for heat dissipation.

The clamp assembly can also be referred to as a battery pack or a battery block.

In a preferred embodiment of the clamp assembly, the following additional feature is provided:
a. The recesses of the cell holder have a hexagonal shape.

The hexagonal shape of the recesses of the cell holder or the receptacles for the individual energy storage elements is particularly suitable, as it makes it easy to accommodate the cylindrical round cells without radial play, whereby the round cells are held firmly in position. The hexagonal shape of the receptacles creates a honeycomb-like structure, with the individual recesses each forming a honeycomb cell.

The honeycomb structure has the further advantage that a substantially constant wall thickness can be achieved over the entire cell holder, which is advantageous for the stability of the injection-moulded part. The honeycomb structure also allows a reduction in material and weight compared to conventional cell holders with a different structure.

In preferred embodiments, the clamp assembly is characterized by the following additional feature:
a. The individual recesses are each provided with at least one clamping rib pointing into the interior of the recess.

The individual round cells can be held reliably and without play in the clamp assembly by one or preferably several clamping ribs, which protrude into the interior of the individual recesses, i.e. into the interior of the individual receiving spaces of the cell holder.

In further, preferred embodiments of the clamp assembly, at least one of the following additional features is provided:
a. The individual recesses are each provided with two or more clamping ribs pointing into the interior of the recess;
b. The recesses of the cell holder have a hexagonal shape and the individual recesses of the cell holder are provided with three clamping ribs pointing into the interior of the recess;
c. The clamping ribs of the individual recesses of the cell holder are positioned on non-adjacent walls of the individual recesses.

Preferably, the aforementioned features a. and b., and preferably, the aforementioned features a., b. and c. are realized in combination with one another.

Thanks to these preferred designs of the cell holder, the cylindrical round cells can be held in the cell holder reliably and without play, even if manufacturing tolerances occur. Additional dynamic loads during operation of a battery, which can have a negative effect on the welded connections between the individual round cells and their respective electrical arresters, are avoided.

Preferably, the clamping ribs are arranged on the inner walls of the recesses in such a way that the clamping ribs are only located on every second inner wall. With a hexagonal shape of the recesses and therefore six inner walls and three clamping ribs, of opposite walls only one is provided with a clamping rib.

The arrangement of the clamping ribs only on non-adjacent inner walls of the individual recesses or receptacles for the individual cells allows the cells to be held securely in place even if the diameters of the round cells differ slightly as a result of production tolerances.

The clamp assembly is preferably characterized by the following additional feature:
a. The cell holder has a structure wherein adjacent recesses are bounded by an intermediate wall.

The intermediate wall is a common wall that bounds both of the adjacent recesses or receptacles of the cell holder in one direction.

In a preferred manner, the following additional feature is provided with respect to this aspect:
a. The intermediate walls each have only one clamping rib.

This feature ensures that the intermediate wall, which is provided with a clamping rib on one side, can be pushed in the direction of the adjacent recess which is bound by the same wall when a round cell is inserted, so that tolerance differences in the diameter of the round cells can be compensated for. This would not be possible if the intermediate wall would bear a clamping rib on both of its sides.

Preferably the cell holder has a honeycomb structure in which the individual recesses (cell receptacles) each have six walls. Preferably a clamping rib is positioned on three of the six walls. The walls of adjacent recesses (cell receptacles) are formed by intermediate walls, wherein there is always only one clamping rib on an intermediate wall. This means that preferably in no case are there two clamping ribs on opposing sides of the same wall. Due to the elasticity of the thin plastic walls of the cell holder, this results in a spring effect of the wall into the neighboring cell receptacle. This means that each energy storage element can be clamped and held in a kind of “oversize fit”, ensuring that the energy storage elements are clamped without play in all cell receptacles of the cell holder, for example in 154 cell receptacles.

These measures can compensate for tolerances (manufacturing tolerances) that occur with regard to the cell diameter in general. In addition, any differences in cell diameters on the positive pole side and the negative pole side of the cells can also be compensated for. Such differences between the two pole sides of a cell can, for example, be in a nominal range of 0.1-0.2 mm.

In general, tolerances cannot be avoided in the production of plastic injection molded parts. These tolerances are for example based on distortion due to different cooling of the structures at different points of the injection molded part. Tool tolerances, tool separations etc. also play a role. Therefore, with conventional cell holders, repeatability of dimensional accuracy cannot be reliably guaranteed, in the case of a cell holder with several cell receptacles. The present disclosure addresses this primarily via flexible partition walls and clamping ribs in the individual cell receptacles of the cell holder.

For a good clamping effect, it is advantageous if the tolerances of the cells and also of the cell holder are only small, especially with regard to the individual cell receptacles with the clamping ribs. A commonly accepted tolerance is for example ±0.5 mm, more preferably ±0.2mm, preferably ±0.1 mm.

Conventional, rigid cell holders, which have for example round cell receptacles and in which all the walls of the cell receptacles are clamped without the walls being able to move, have the disadvantage that the cell receptacles cannot be oversized. By oversizing cell receptacles the problem that some of the cells cannot be inserted into receptables is solved, but smaller cells will have play in the receptables. It is therefore usually necessary to use a two-part cell holder and/or to glue the cells in the cell holder.

Despite its one-piece design, the cell holder ensures secure clamping of the cells due to the spring effect of the flexible intermediate walls, so that a tolerance compensation for the production-related tolerances of the cells and the cell holder is achieved.

In preferred embodiments of the clamp assembly, the following additional feature is provided:
a. The energy storage elements are lithium-ion cells or sodium-ion cells.

Lithium-ion cells are widely used for a variety of battery applications, as lithium-ion cells are characterized above all by a high energy density at a comparatively low weight. However, sodium-ion cells are also becoming increasingly interesting. These usually have a comparatively low energy density. However, the availability of sodium exceeds that of lithium many times over.

In general, lithium-ion cells are based on the use of lithium, which can move back and forth between the electrodes of the energy storage element in the form of ions.

Sodium ions are based on the use of sodium, which can move back and forth between the electrodes of the energy storage element in the form of ions.

The negative electrode and the positive electrode of sodium and lithium-ion energy storage elements are often formed by so-called composite electrodes, which include electrochemically inactive components as well as electrochemically active components.

In principle, all materials that can absorb and release lithium ions can be used as electrochemically active components (active materials) for secondary lithium-ion energy storage elements. For example, carbon-based particles such as graphitic carbon are used for the negative electrode. Active materials for the positive electrode can be, for example, lithium cobalt oxide (LiCoO₂), lithium manganese oxide (LiMn₂O₄), lithium iron phosphate (LiFePO₄) or derivatives thereof. The electrochemically active materials are usually contained in the electrodes in particle form.

The active materials are usually applied as a layer on a ribbon-shaped current collector. The current collector is an electrochemically inactive component of the energy storage element. Metallic foils that serve as a carrier for the respective active material are suitable as current collectors. The current collector for the negative electrode (anode current collector) can be made of copper or nickel, for example, and the current collector for the positive electrode (cathode current collector) can be made of aluminum, for example. Furthermore, the electrodes can comprise an electrode binder (e.g. polyvinylidene fluoride (PVDF) or another polymer, for example carboxymethyl cellulose), conductivity-improving additives and other additives as electrochemically inactive components. The electrode binder ensures the mechanical stability of the electrodes and often also ensures that the active material adheres to the current collectors.

Solutions of lithium salts such as lithium hexafluorophosphate (LiPF6) in organic solvents (e.g. ethers and esters of carbonic acid) are suitable as electrolytes for lithium-ion energy storage elements.

In cylindrical round cells, the electrodes of the cell are preferably arranged in the form of a coil, with at least one ribbon-shaped separator arranged between the ribbon-shaped electrodes. In other embodiments, the electrodes can be in stacked form.

The present disclosure further provides a battery having a plurality of energy storage elements. This battery is characterized by the following features:
a. The battery comprises a housing;
b. At least one clamp assembly as described above is arranged in the housing;
c. The energy storage elements of the clamp assembly are bonded and/or electrically contacted to structural elements of the housing and/or the battery via their end faces which are located outside the cell holder.

The term battery here also includes a battery module, whereby several battery modules can be combined to form a larger battery system. Depending on the design of the battery or battery module, one or more clamp assemblies with the appropriate number of energy storage elements for the respective application can be provided in the housing.

The housing of the battery can be a metallic housing. However, other housing designs are also possible, for example a housing made of plastic and/or carbon fibers.

For practical reasons, prismatic housing shapes are suitable, as they are easy to stack, for example. The housing can also be designed in such a way that it can be installed in a space-saving manner, for example with regard to applications in the automotive sector or for use as a bicycle accumulator or similar.

The structural element of the housing and/or the battery, to which the end faces of the energy storage elements are bonded, for example, can be the inside of the housing or another support structure within the housing.

The structural element of the housing and/or the battery, with which the end faces of the energy storage elements are electrically contacted, can, for example, be a printed circuit board. This printed circuit board can also be the carrier for battery management electronics, via which the individual energy storage elements of the terminal assembly are electrically connected to each other.

In preferred embodiments, one end face of each energy storage element is bonded to a structural element of the housing. The energy storage elements are preferably electrically contacted via the other end face of the energy storage elements. Suitable conductor elements, cell connectors or the like can be provided for this purpose, which are welded to the respective end face area of the energy storage elements.

Preferably at least one of the following additional features is provided in preferred embodiments of the battery:
a. The bonding is carried out with a thermally conductive potting compound, in particular a thermally conductive potting resin;
b. The bonding causes heat dissipation from the energy storage elements;
c. The bonding provides electrical insulation of the energy storage elements from the housing.

Preferably, the aforementioned features a. and b., or a. and c., or in a preferred manner the aforementioned features a., b. and c., are realized in combination with one another.

Epoxy-, polyurethane-, silicone-based and, preferably, polybutadiene-based potting compounds can be used, for example. These materials have the advantage that, on the one hand, they fix the individual energy storage elements of the clamp assembly and thus the clamp assembly as a whole in the housing. On the other hand, electrical insulation of the energy storage elements from the housing is achieved, especially if the housing is metallic. In addition, these materials allow heat to be dissipated from the energy storage elements, so that heat generated during operation of the battery and in particular during the discharging or charging processes can be dissipated well and the battery does not overheat.

In addition, the battery can be equipped with active temperature control means, for example with a cooling plate or other cooling devices. By means of a thermally conductive potting compound, in particular a thermally conductive potting resin, the energy storage elements can be connected to corresponding temperature control devices, for example by bonding them to a cooling plate or another cooling element. In this case, such a cooling element serves as a structural element to which the energy storage elements of the clamp assembly are bonded.

The bonding with the potting compound can be carried out in particular in such a way that the potting compound encloses the free ends of the energy storage elements to a height of a few millimetres, for example. In this way, the energy storage elements are fixed and secured to the respective structural element. Furthermore, the energy storage elements are thereby advantageously electrically insulated from the battery housing, while at the same time enabling direct heat transfer and surface heat dissipation to the battery housing.

Materials that have a low viscosity and/or are self-levelling are suitable for the casting compound. Good adhesion to plastics and metals and sufficient thermal conductivity are also useful. Furthermore, it is advantageous if the material for the casting compound has self-extinguishing properties in the event of a fire.

Advantageously, the materials used for the casting compound are characterized by a wide temperature application range of −60° C. to +150° C., for example, as well as a good balance between high thermal conductivity and viscosity and good adhesion values on plastics and metals.

The viscosity of preferred materials for the potting compound can, for example, be in a range of 4,000-5,500 mPa*s (Brookfield viscosity at 25° C., test standard ISO 2555), in particular in a range of 4,500-5,000 mPa*s (Brookfield viscosity at 25° C.), and preferably 4,700 mPa*s (Brookfield viscosity at 25° C.).

The thermal conductivity of preferred materials for the casting compound can, for example, be in a range of 0.80-1.10 W/m*K (test standard ASTM D 7984), in particular in a range of 0.90-1.00 W/m*K, and preferably 0.95 W/m*K.

Preferably, polybutadiene potting resins, in particular two-component polybutadiene potting resins, can be used.

The present disclosure also comprises a cell holder for cylindrical round cells. The cell holder is a one-piece cell holder and is made of plastic. It comprises a plurality of recesses or receptacles in a triangular or polygonal shape with a corresponding number of inner walls. The cell holder is intended for clamping a plurality of cylindrical round cells. The individual round cells are each to be clamped into a recess in the cell holder, with the cell holder engaging in the area of the shell surface of the round cells so that the end faces of the individual round cells are positioned outside the cell holder.

The cell holder preferably forms a honeycomb-like structure in that the individual recesses of the cell holder have a hexagonal shape.

Furthermore, the individual recesses are preferably provided with at least one clamping rib pointing into the interior of the recess. In particular in the case of a hexagonal shape of the recesses, three clamping ribs are preferably provided per recess. The clamping ribs are preferably offset in relation to the adjacent recess, so that in the case of an intermediate wall between two adjacent recesses, this intermediate wall is only provided with a clamping rib on one side.

With regard to further features of the cell holder, reference is made to the above description.

Further features and advantages are shown in the following description of preferred embodiments in conjunction with the drawings. The illustrated features can be realized individually or in combination with other illustrated features.

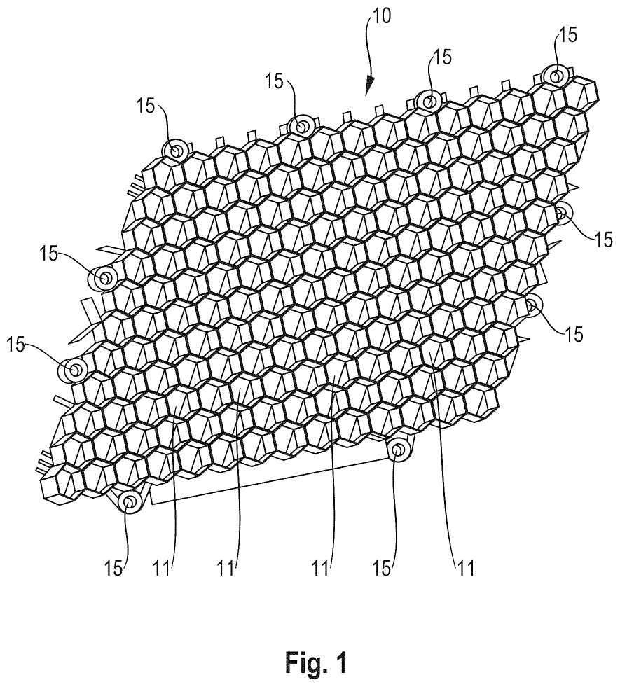

FIG. 1 shows an exemplary embodiment of a cell holder 10. In this embodiment, the cell holder 10 forms a honeycomb-like structure with individual recesses 11 having a hexagonal shape. The recesses 11 are intended to receive individual cylindrical round cells, which are to be clamped into the recesses 11. It is intended that the cell holder engages in the area of the shell surface of the individual round cells, so that the end faces of the round cells are outside the cell holder 10.

The recesses 11 of the cell holder 10 are arranged in a regular pattern, with a total of fourteen rows, each with eleven recesses, being provided in this example. This means that 154 cylindrical round cells can be inserted into this cell holder.

Circular apertures 15 are provided at sides of the cell holder 10, which serve to fasten the cell holder 10 in a battery housing. The openings 15 are preferably designed as molded sleeves for the passage of fastening screws so that the cell holder 10 with the inserted round cells can be fastened in a battery housing.

The cell holder 10 is a one-piece cell holder. No further cell holder element is required. Of course, several of the cell holders shown here can be installed in a battery or, for example, a battery module. Each of these cell holders would then be equipped with 154 cylindrical round cells according to this embodiment example.

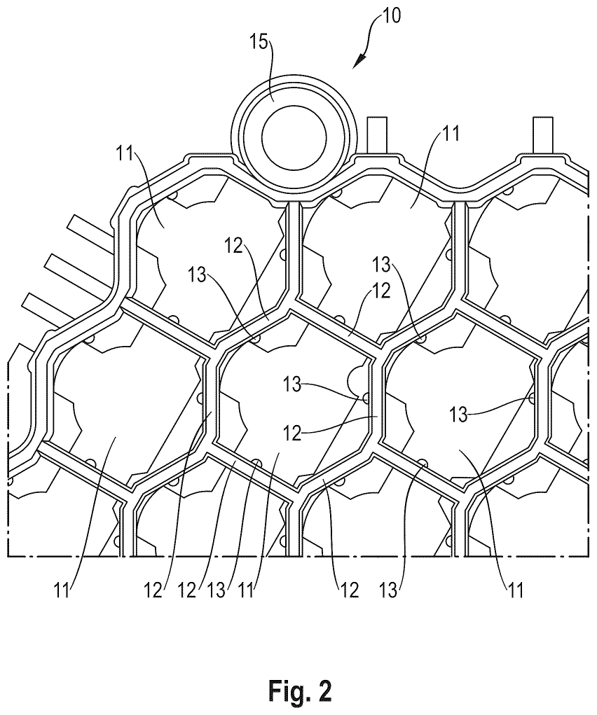

FIG. 2 shows a more detailed view of the cell holder 10. The individual recesses 11 or receptacles for the cylindrical round cells to be inserted are each bounded by six walls 12. Each of the walls 12 are intermediate walls, meaning that they bound two adjacent recesses.

In the preferred embodiment of the cell holder 10 shown here, clamping ribs 13 are provided on three of the six walls of the recesses 11. The clamping ribs 13 are designed in such a way that they provide a stable clamping closure for the cylindrical round cells to be inserted.

The clamping ribs 13 are located on non-adjacent walls of the recesses 11, i.e. the clamping ribs are located on every second wall. There is only one clamping rib 13 per intermediate wall 12.

This arrangement of the clamping ribs 13 makes the cell holder flexible. The respective wall can, if necessary, deviate slightly if a cylindrical round cell is inserted. This design of the cell holder 10 allows advantageous compensation of tolerance differences in the sizes of the cylindrical round cells.

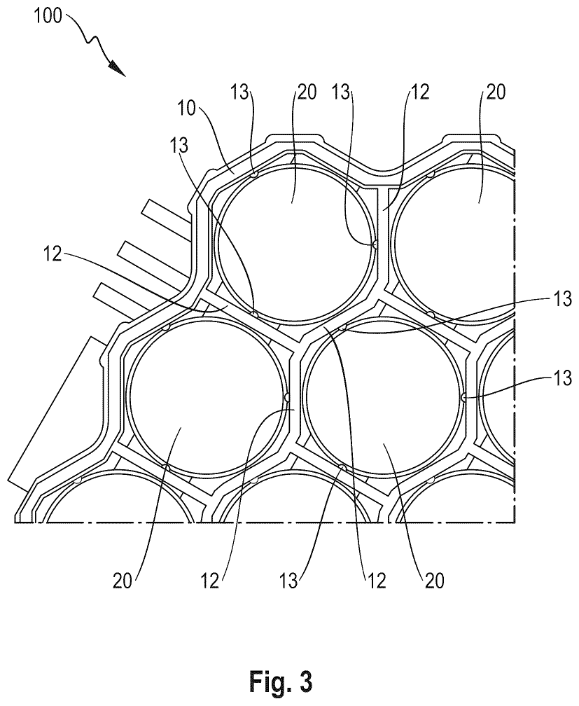

FIG. 3 shows a top view of a section of the cell holder 10 with inserted energy storage elements (cylindrical round cells) 20. Every second wall of a recess in the cell holder 10 is equipped with a clamping rib 13. The inserted round cells 20 are held on the three clamping ribs 13. Due to the elasticity of the honeycomb structure of the cell holder 10, the intermediate walls can, if necessary, be pushed in the direction of the neighboring recess.

In the cell holder 10, the energy storage elements 20 are held firmly in the intended position without radial play. Due to the design of the clamping ribs 13 in the honeycomb structure and its elasticity, it is possible to hold the individual energy storage elements securely in place despite their production tolerances and therefore slightly varying diameters.

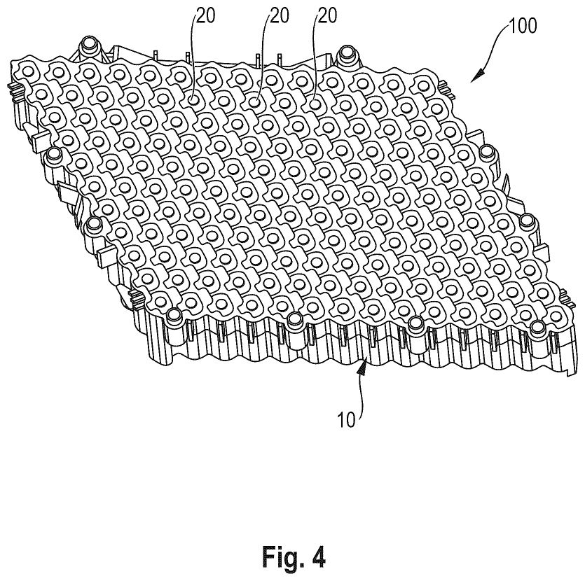

FIG. 4 shows a view of the upper side of a clamp assembly 100, which is formed by a cell holder 10 fully equipped with cylindrical round cells 20. The end faces of the round cells 20 exposed on this side are available for electrical contacting of the energy storage elements. For example, conventional cell connectors can be welded onto this side in order to make electrical contact with the energy storage elements.

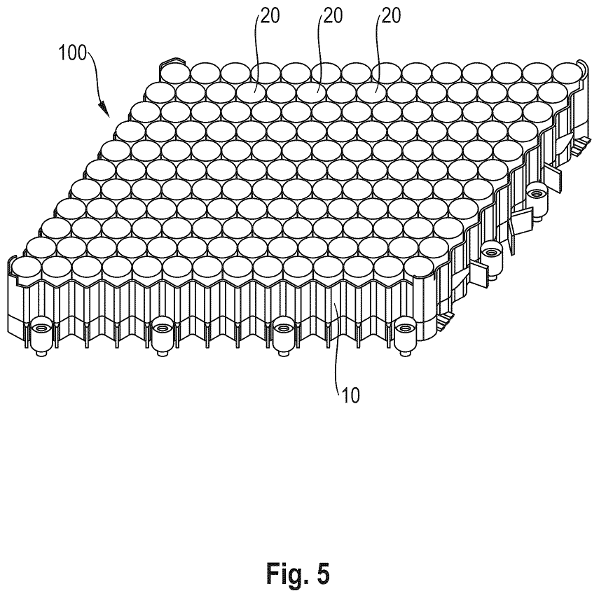

FIG. 5 shows a view of the underside of the clamp assembly 100. The ends of the respective round cells 20 protruding from the cell holder 10 are exposed, as the cell holder 10 engages in the shell surfaces of the round cells 20. The free ends of the energy storage elements 20 that protrude upwards can be fixed to a structural element of a battery housing using a thermally conductive potting resin, for example. In addition to fixing, the potting resin can provide electrical insulation of the energy storage elements from the housing. At the same time, this bonding can achieve optimum heat dissipation from the energy storage elements by transferring the heat to the housing and dissipating it in this way.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements. e.g., A, any subset from the listed elements, e.g., A and B. or the entire list of elements A, B and C. PATENT CLAIMS

1. A clamp assembly for a plurality of electrical energy storage elements in the form of cylindrical round cells, each respective electrical energy storage element having a shell surface and two end faces, the clamp assembly comprising:
a one-piece cell holder comprising a plurality of recesses each having a triangular or polygonal shape and a corresponding number of walls,
wherein the cell holder is made of plastic,
wherein each respective electrical energy storage element is clamped in a respective recess in the cell holder with the cell holder engaging in a region of the shell surface of the respective electrical energy storage element, and
wherein end faces of each respective energy storage element are located outside the cell holder.

2. The clamp assembly according to claim 1, wherein the plurality of recesses each have a hexagonal shape.

3. The clamp assembly according to claim 1, wherein the plurality of recesses are each provided with at least one clamping rib pointing into an interior thereof.

4. The clamp assembly according to claim 3, wherein at least one of:
the plurality of recesses are each provided with two or more clamping ribs pointing into the interior thereof;
the plurality of recesses each have a hexagonal shape and are provided with three clamping ribs pointing into the interior thereof; and/or
the clamping ribs of each respective recess are positioned on non-adjacent walls of the respective recess.

5. The clamp assembly according to claim 1, wherein the cell holder has a structure wherein the plurality of recesses are bounded by intermediate side walls.

6. The clamp assembly according to claim 5, wherein the intermediate side walls each have only one clamping rib.

7. The clamp assembly according to claim 1, wherein the energy storage elements are lithium-ion cells or sodium-ion cells.

8. A battery, comprising:
at least one clamp assembly according to claim 1;
the plurality of electrical energy storage elements in the form of cylindrical round cells; and
a housing;
wherein the at least one clamp assembly is arranged in the housing, and
wherein the plurality of electrical energy storage elements are bonded and/or electrically contacted to structural elements of the housing and/or the battery via their end faces located outside the cell holder.

9. The battery of claim 8, wherein at least one of:
the bonding is carried out with a thermally conductive potting compound,
the bonding causes heat dissipation from the energy storage elements, and/or
the bonding provides electrical insulation of the energy storage elements from the housing.
